(19) United States
(12) Patent Application Publication
(10) Pub. No.: US 2024/0315235 A1
(43) Pub. Date: Sep. 26, 2024

(54) STEP ATTACHMENT FOR A CLIMBING TREE STAND

(71) Applicant: TAYLOR VINCENT HARPER, HUNTSVILLE, AL (US)

(72) Inventor: TAYLOR VINCENT HARPER, HUNTSVILLE, AL (US)

(21) Appl. No.: 18/186,311

(22) Filed: Mar. 20, 2023

(51) Int. Cl. A01M 31/02; A63B 27/02

(52) U.S. Cl. CPC A01M 31/02; A63B 27/02

(57) ABSTRACT

A step attachment for a climbing tree stand includes a stiffening member housed within the cavity of a length of hollow tubing having opposite ends. The ends are compressed and sealed forming flattened end portions that are inserted into first and second adjustment slides.

### BACKGROUND

### Field

The present disclosure relates generally to climbing tree stands for hunting.

### Description of the Problem and Related Art

A climbing tree stands allows a hunter to scale a trees and to perch in up in the tree while awaiting game animals to pass within weapon range. Typical climbing tree stands include a base having a platform upon which a hunter may stand, and which is secured to a tree with a wrap-around cable, and a seat situated above the base and also secured to the tree with a wrap-around tree cable. Examples of such tree stands abound in the art, a instance of which is described in U.S. Pub. App. No. U.S. Ser. No. 09/922,268 by Lane.

One drawback of these apparatuses is that in mounting climbing tree stand to a tree, the base may be angled upward. This results in a first step of considerable height for the hunter to clamber upon the platform. The accessory described herein addresses this shortcoming by providing an intermediate step allowing the hunter to more easily ascend onto the base platform.

### SUMMARY

For purposes of summary, certain aspects, advantages, and novel features are described herein. It is to be understood that not necessarily all such advantages may be achieved in accordance with any one particular embodiment. Thus, the apparatuses or methods claimed may be embodied or carried out in a manner that achieves or optimizes one advantage or group of advantages as taught herein without necessarily achieving other advantages as may be taught or suggested herein.

In one embodiment, a step attachment for a climbing tree stand includes a stiffening member housed within the cavity of a length of hollow tubing having opposite ends. The ends are compressed and sealed forming flattened end portions that are inserted into first and second adjustment slides.

### BRIEF DESCRIPTION OF THE DRAWINGS

The apparatus is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an exemplary step attachment for a climbing tree stand; and

FIG. 2 depicts the exemplary step attachment of FIG. 1 attached to a notional climbing tree stand base.

### DETAILED DESCRIPTION

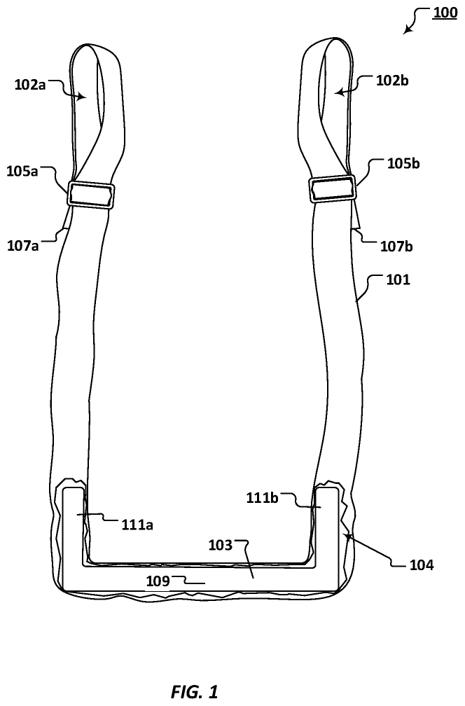

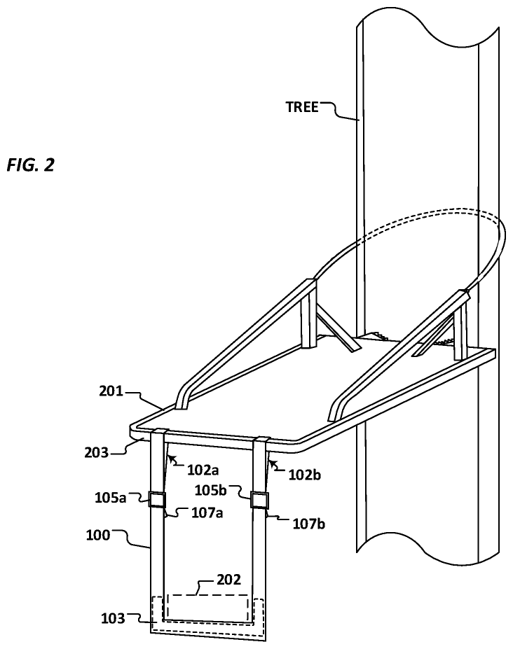

The various embodiments of the step attachment for a climbing tree stand and their advantages are best understood by referring to FIGS. 1 and 2 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

FIG. 1 is an illustration of an exemplary embodiment of step attachment 100 which comprises a flexible, hollow tubing 101 that is preferably a webbed tubing having opposite ends 107a, 107b. The ends 107a, b have been sealed and are compressed such that the webbed tubing 101 is flattened enough to be inserted into adjustment slides 105a, 105b. As shown in the illustration, loops 102a, 102b have been formed by inserting the flattened webbed tubing ends into the slides 105a, b, folding the ends 107a, b and inserting into the slides 105a, b again.

The middle portion of the step attachment 101 is not been flattened as the ends are, and so a cavity 104 is formed defined by the walls of the webbed tubing 101. A stiffener 103, shown in the cutaway section, is housed within the cavity 104 and is formed to have a horizontal section 109 which forms a step when the step attachment is secured to a tree stand base (as depicted in FIG. 2).

In one embodiment, stiffener 103 is “u”-shaped formed with vertical sections 111a, 111b of either end. This helps prevent stiffener 103 from moving within cavity 104, insuring a horizontal first step.

With reference to FIG. 2, step attachment 100 is shown installed on a tree stand base 201. To secure step attachment 100 to base 201, ends 107a, b are removed from adjustment slides 105a, b and the end portions of webbed tubing 101 are wrapped around the front bar 203 of base 201 such that ends 107a, b are folded back upon webbed tubing 101 forming loops 102a, b. Ends 107a, b are inserted into respective adjustment slides securing step attachment to front bar 203. Stiffener 103 forms a horizontal step 202.

Stiffener 103 is preferably formed a highly durable material such as a metal material, for example, a length of reinforcement bar (i.e., rebar). Stiffener should ideally resist deformation, or breaking, at weights up to about 400 lbs. If using rebar, a gauge of about ⅜ inch should be adequate. Alternatively, stiffener 103 could be formed from a highly strong, durable plastic such as ultra-high-molecular-weight polyethylene.

Webbed tubing 101 should be about five feet in length and similarly be of such a material and gauge to be able to suspend up to about 400 lbs. Nylon is a suitable material.

As described above and shown in the associated drawings, the present invention comprises a step attachment for a climbing tree stand. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A step attachment for a climbing tree stand comprising:
a length of hollow tubing having opposite ends, said ends being compressed and sealed forming flattened end portions, said hollow tubing defining an internal cavity;
first and second adjustment slides; and
a stiffener within said cavity for forming a substantially horizontal step.

2. The step attachment of claim 1, wherein said stiffener is “u”-shaped.

3. The step attachment of claim 2, wherein said stiffener is formed from one of a metal and a plastic.

4. The step attachment of claim 2, wherein said stiffener is a length of rebar.

5. The step attachment of claim 1, wherein said stiffener is formed from one or a metal and a plastic.

6. The step attachment of claim 5, wherein said stiffener is length of rebar.

7. The step attachment of claim 6, wherein said length of rebar is “u”-shaped.

8. A step attachment for a climbing tree stand base, the base including a platform and a frontal bar, said step attachment comprising:
a stiffening member housed within a cavity defined by a length of hollow webbed tubing, wherein the webbed tubing comprises first and second end portions having loops secured around the frontal bar, the stiffening member forming a substantially horizontal step.

9. The step attachment of claim 8, wherein the length of hollow webbed tubing comprises first and second adjustment slides.

10. The step attachment of claim 8, wherein the stiffening member is one of a metal and a plastic.

11. The step attachment of claim 10, wherein the stiffening member is a length of rebar.

12. The step attachment of claim 10, wherein the stiffening member is “u”-shaped.
